(19) United States
(12) Patent Application Publication
(10) Pub. No.: US 2022/0352723 A1
(43) Pub. Date: Nov. 3, 2022

(54) METHOD FOR FEEDING ELECTRICAL POWER INTO AN ELECTRICAL SUPPLY GRID

(71) Applicant: Wobben Properties GmbH, Aurich (DE)

(72) Inventor: Johannes Brombach, Berlin (DE)

(21) Appl. No.: 17/732,040

(22) Filed: Apr. 28, 2022

(30) Foreign Application Priority Data
Apr. 28, 2021 (EP) 21170991.0

(51) Int. Cl. H02J 3/38; H02J 3/18; H02J 3/00; H02J 3/12; G05B 19/042

(52) U.S. Cl. CPC H02J 3/381; H02J 3/18; H02J 3/001; H02J 3/12; G05B 19/042; H02J 2300/24; H02J 2300/28; G05B 2219/2639

(57) ABSTRACT

A method for exchanging electrical power between an infeed unit, in particular a wind power installation or a wind farm, and an electrical supply grid at a grid connection point is provided. The exchange comprises exchanging active and reactive power, and the exchange of the active power is controlled based on a frequency-dependent and voltage-dependent active power control function. The active power control function specifies an additional active power to be fed in based on a captured grid frequency and a captured grid voltage. The exchange of the reactive power is controlled based on a frequency-dependent and voltage-dependent reactive power control function, where the reactive power control function specifies an additional reactive power to be fed in based on the captured grid frequency and the captured grid voltage. The control functions are set based on at least one grid characteristic and/or at least one grid state of the grid.

### BACKGROUND

### Technical Field

The present invention relates to a method for exchanging electrical power between an infeed device, such as a wind power installation, wind farm or photovoltaic installation, and an electrical supply grid. The invention also relates to such an infeed unit, in particular a wind power installation or a wind farm.

### Description of the Related Art

Wind power installations or wind farms or other infeed units (infeed devices) for feeding electrical power into an electrical supply grid are known. They may also be synonymously referred to as infeed apparatuses. Such infeed apparatuses are used not only to provide the electrical power which is fed in, but also to operate, support and/or stabilize the electrical supply grid.

If electrical supply grids have hitherto been predominantly or exclusively operated by means of large-scale power plants with directly coupled synchronous generators, the proportion of other infeed apparatuses is now increasing in some electrical supply grids. In particular, the proportion of regenerative energy sources, which are usually in the form of converter-controlled infeed apparatuses, is increasing. They therefore feed power into the electrical supply grid by means of converters or inverters. As a result, the fundamental behavior of the electrical supply grid can also change.

For example, in electrical supply grids which are predominantly or exclusively operated by means of directly coupled synchronous generators, there is a fixed relationship between a power deficit and a frequency change. Many reactions of the electrical supply grid can actually be attributed to the physical behavior of directly coupled synchronous generators and can also be well predicted. The behavior of such an electrical supply grid is well known in this case.

On the basis of such known grid characteristics, it is possible to suggest appropriate strategies for how infeed apparatuses react to changes in the electrical supply grid. In particular, voltage-dependent phase angle control systems and frequency-dependent power control systems, which presuppose certain characteristics of the electrical supply grid, are known.

With an increasing proportion of converter-controlled infeed apparatuses, such relationships may change, which may also influence the selected strategies. In particular, stabilization known from directly coupled synchronous generators may decrease or even cease. In order to counteract such effects, converter-controlled infeed apparatuses may be accordingly programmed for this purpose in such a manner that they have particular behavior patterns. These need not necessarily be the behavior patterns known from the directly coupled synchronous generators. In addition, not every behavior pattern can be programmed and it is thus scarcely possible to simulate an identical behavior of directly coupled synchronous generators by means of converter-controlled infeed apparatuses.

In addition, wind power installations or wind farms and photovoltaic installations which make up a large part of such converter-controlled infeed apparatuses often have fluctuating energy sources. Depending on the available solar power and/or available wind power, converter-controlled infeed apparatuses may provide a different amount of power. This can also change the general characteristic of the electrical supply grid. If, for example, there is therefore a large proportion of wind power installations, as measured by the installed power, their behavior may dominate the behavior of the electrical supply grid if there is a lot of wind. However, if there is little wind, a proportion of directly coupled synchronous generators may in turn be dominant, with the result that a different grid characteristic is then present.

In addition, converter-controlled infeed apparatuses are also often more greatly distributed than large-scale power plants with directly coupled synchronous generators.

### BRIEF SUMMARY

Controlling an electrical supply grid with different and/or changing grid characteristics as stably as possible is described herein.

The disclosure proposes a method for exchanging electrical power. Accordingly, the method relates to the exchange of electrical power between an infeed unit (infeed device), which may a wind power installation, wind farm or photovoltaic installation, among others, and an electrical supply grid at a grid connection point. The infeed unit is, in particular, in the form of a wind power installation or a wind farm having a plurality of wind power installations. The feeding of electrical power into the electrical supply grid is essentially proposed, but it also comes into consideration that the infeed unit itself takes electrical power from the electrical supply grid, in particular when this is proposed for the purpose of stabilizing the electrical supply grid. Therefore, the proposed method relates to the exchange of electrical power between the electrical supply grid and the infeed unit, which therefore comprises transmitting electrical power in both directions.

A wind power installation or a wind farm having a plurality of wind power installations is proposed, in particular, as the infeed unit. A wind power installation and a wind farm feed power into the electrical supply grid with the aid of a converter or inverter. Such a feeding-in operation is referred to as a converter-controlled feeding-in operation. Therefore, it is preferably proposed that the infeed units are converter-controlled infeed units. This also applies to most wind power installations and wind farms.

The method is based on an electrical supply grid which has a variable grid voltage and a variable grid frequency and is characterized by a nominal voltage and by a nominal frequency. The exchange of electrical power comprises exchanging active power and exchanging reactive power. However, active power and reactive power need not necessarily always be exchanged at the same time.

It is also proposed that the exchange of the active power is controlled on the basis of a frequency-dependent and voltage-dependent active power control function. The active power control function specifies an additional active power to be fed in in addition to an active power basic value on the basis of the captured grid frequency and on the basis of the captured grid voltage. A dual dependence is therefore provided here and the additional active power is therefore specified on the basis of the captured grid frequency and on the basis of the captured grid voltage.

If the infeed unit is a wind power installation or a wind farm, this available power may depend, in particular, on the available wind. On the basis of this, a wind-dependent basic power or other basic power, in particular, can be fed in, specifically at the level of the active power basic value. However, this basic power or this active power basic value may also be lower than the power available to be fed in. The active power control function therefore determines, as the additional active power, a control power value, by which the basic power which is fed in or the active power basic value is changed. In particular, such a control power value may have the value 0 if the captured grid frequency corresponds to the nominal frequency and the captured grid voltage corresponds to the nominal voltage.

In this respect, such a situation may form a starting point for the active power control function. With increasing frequency, the control power value and therefore the additional active power to be fed in can be reduced further, in particular. With increasing voltage, the additional active power to be fed in and therefore the control power value can also be increased further, to name two preferred variants. For the purpose of simplification, reference may also be made to the additional active power to be fed in as the active power to be fed in, which is not intended to exclude the fact that an active power basic value may also be included.

The dual dependence of the additional active power on the basis of the grid frequency and the grid voltage can be implemented by means of two separate functions which can each also be represented as a characteristic curve. One of these functions or characteristic curves may specify a first partial control power value on the basis of the captured grid frequency and the other function or characteristic curve may specify a second partial control power value on the basis of the captured grid voltage. These two partial control power values can then be added to form the control power value.

However, a dual dependence which can be specified by means of a three-dimensional characteristic area also comes into consideration. Such a three-dimensional characteristic area therefore respectively specifies an associated control power value for a pair of values for the captured grid frequency and the captured grid voltage. Such a characteristic area may possibly also be specified as a function dependent on two variables.

This dual dependence of the active power control function on the captured grid frequency and on the captured grid voltage is proposed, in particular, with regard to the method being able to be adapted to different electrical supply grids or to a changing or changeable electrical supply grid. In particular, it has been recognized that there is a strong dependence between a power requirement and a grid frequency in a conventional electrical supply grid in which only directly coupled synchronous generators feed power into the electrical supply grid and are at least dominant. In such an electrical supply grid, a change in the grid frequency is an indication of a power oversupply or undersupply. A dependence between the power and the grid voltage is rather low.

In contrast, in an electrical supply grid in which converter-controlled infeed units predominantly feed in power, there may be a stronger dependence between the active power and the grid voltage, whereas the relationship between the active power which is fed in and the grid frequency has decreased in comparison with conventional electrical supply grids. For this reason, this dual dependence is proposed in order to be able to take both aspects into account.

Provision is also made for the exchange of the reactive power to be controlled on the basis of a frequency-dependent and voltage-dependent reactive power control function, wherein the reactive power control function specifies an additional reactive power to be fed in in addition to a reactive power basic value on the basis of the captured grid frequency and on the basis of the captured grid voltage. In this case too, the reactive power control function can be specified by means of two individual control functions, in particular characteristic curves, or by means of a characteristic area. The explanations of the active power control function can be analogously applied here. For the purpose of simplification, reference can also be made to the additional reactive power to be fed in as the reactive power to be fed in, which is not intended to exclude the fact that a reactive power basic value may also be included.

For feeding in or exchanging reactive power, there is no need for a reactive power basic value which could describe a permanent reactive power to be fed in. In this respect, it comes into consideration here that the reactive power to be fed in or exchanged has the value 0 in case of captured nominal frequency and captured nominal voltage. If the grid voltage increases, provision may be made for the reactive power fed in to be reduced, in particular also to values below 0 in that case. If the frequency increases, provision may likewise be made for the reactive power to be reduced.

Nevertheless, it is possible, however, for there to be a reactive power basic value for feeding in power irrespective of the captured grid frequency and the captured grid voltage. Such a reactive power basic value may be specified, in particular, by a grid operator.

In this case too, the dual dependence of the reactive power to be exchanged is provided with a view to the proposed method being intended to be usable for different electrical supply grids or being intended to be able to adjust to changing electrical supply grids.

It is therefore also proposed that the active power control function and the reactive power control function respectively form a control function and are set on the basis of at least one grid characteristic and/or at least one grid state of the electrical supply grid.

A comparatively simple possible way of setting said functions involves respectively providing, for the active power control function and the reactive power control function, a pre-factor which is changed on the basis of at least one grid characteristic and/or at least one grid state. These changes may be different for the active power control function and the reactive power control function, in particular may also be opposed.

In particular, however, it also comes into consideration that a weighting is respectively provided for the dependence on the captured grid frequency, on the one hand, and for the dependence on the captured grid voltage, on the other hand. This may be provided for both control functions, that is to say for the active power control function and the reactive power control function. Four weightings may therefore be provided. Each weighting may be provided as a weighting factor or as a more complex weighting function. As a result, it is possible to achieve the situation, for example, in which, in the case of a conventional electrical supply grid, the active power to be fed in depends more greatly on the captured grid frequency, whereas the reactive power to be fed in depends more greatly on the captured grid voltage. If there is no conventional electrical supply grid in which converter-controlled infeed units, in particular, are dominant, the behavior can be changed to a behavior in which the active power to be fed in depends more greatly on the captured grid voltage and the reactive power to be fed in depends more greatly on the captured grid frequency, to name an illustrative example.

However, the active power control function and/or the reactive power control function can also be set by storing different control functions, from which a selection is made on the basis of at least one grid characteristic and/or at least one grid state.

The setting both of the active power control function and of the reactive power control function may mean that individual characteristic curves or characteristic areas are changed.

If a characteristic area is respectively used to control the active power and the reactive power or if the active power control function and the reactive power control function can be represented as a characteristic area, the magnitude and direction of a gradient of each characteristic area can be respectively changed by means of the setting operation. In particular, each characteristic area may have a characteristic area center point which denotes the point in the characteristic area at which the nominal frequency and the nominal voltage are present. For this characteristic area center point, it is proposed that the magnitude and phase of its gradient are set if the relevant active power control function or reactive power control function is set. The gradient of the characteristic area center point may be referred to as a center point gradient. In particular, it is proposed that the center point gradient is set on the basis of at least one grid characteristic and/or on the basis of at least one grid state.

It has been recognized here, in particular, that a change in the electrical supply grid may have different effects on a frequency dependence, on the one hand, and a voltage dependence, on the other hand. The characteristic area then changes not only the amplitude but also the direction of its slopes. This is reflected, in particular, in a change in the magnitude and direction of the center point gradient.

A grid characteristic describes a property of the electrical supply grid which permanently characterizes the electrical supply grid. A grid characteristic is a permanent property which may be characterized or provided by the structure of the electrical supply grid, including connected infeed units, line properties and transformers.

A grid state is a transient property of the electrical supply grid. These include, in particular, grid faults, switch positions in the electrical supply grid and power situations in the electrical supply grid which can also be referred to synonymously and in a simplifying manner as a grid. Power situations describe how much power is fed in and removed and may comprise where and/or by what type of infeed units the electrical power is fed in. The grid state may change constantly and it may also comprise or be characterized by the fact that there is no grid fault.

It is therefore proposed that each of the four control functions is set on the basis of a grid characteristic and/or a grid state. The control functions are therefore not firmly specified, but rather take into account the respective characteristics of the electrical supply grid. At least one grid characteristic and at least one grid state are preferably taken into account at the same time.

A consideration, whether of the grid characteristic or of the grid state, is carried out such that the respective control function is set. Each control function establishes a relationship between an input variable, specifically the grid frequency or grid voltage, and an output variable, specifically active power to be fed in and reactive power to be fed in. This relationship can be specified by means of a characteristic curve or in another manner. If the relationship is specified by means of a functional description, such a functional description may also be represented by a characteristic curve.

According to one aspect, it is proposed that a static converter proportion forms a grid characteristic, wherein a static converter proportion describes a ratio of power which can be fed into the electrical supply grid or a grid section thereof by converter-controlled infeed units to power which can be fed into the electrical supply grid or the grid section overall by all infeed units. In particular, the power which can be fed in is in each case the nominal power or installed power of the respective infeed unit or infeed device (e.g., generator or power plant). In this respect, the static converter proportion describes a ratio of the sum of the installed powers or nominal powers of the connected converter-controlled infeed units to the sum of the installed powers or nominal powers of all connected infeed units.

A grid section is, in particular, a part of an electrical supply grid having an installed power of at least 1 gigawatt (GW). Such a grid section may be defined by coupling points which are used to connect it to the rest of the electrical supply grid. Such coupling points may have, in particular, grid isolating switches and/or transformers for coupling.

The static converter proportion therefore forms a grid characteristic since it relates to the installed powers and therefore not a transient state variable. The powers currently being fed in may vary, in particular on the basis of the present wind situation in the case of wind power installations or wind farms.

However, the static converter proportion allows, in particular, conclusions to be drawn with regard to how quickly and to what extent power changes, in particular active power changes and reactive power changes, are possible. Even when such converter-controlled infeed units do not feed in any active power because, for example, there is not sufficient wind in the case of wind power installations or wind farms, such converter-controlled infeed units may nevertheless use up power in a very fast and very highly controllable manner, specifically consume electrical power from the electrical supply grid. Such a property may be particularly relevant when a large electrical load is suddenly disconnected from the electrical supply grid. This may be effected, for example, when a circuit breaker, via which said load is coupled to the electrical supply grid, responds. In such a case, which may be very relevant and dangerous, too much power is then suddenly available in the electrical supply grid. The method is intended to be able to react as well as possible to this.

If the static converter proportion is high, this also means that the proportion of conventional infeed apparatuses is low. In particular, these conventional infeed apparatuses can reduce their power which is fed in only comparatively slowly or they can usually reduce it only in combination with a frequency increase. Accordingly, the method should be able to react to such a frequency increase by quickly reducing the power, including taking power from the electrical supply grid, if the proportion of conventional infeed units is high. However, if the proportion is low, a different reaction of the electrical supply grid can be expected in the case of the described disconnection of a large load, with the result that the proposed method should also behave differently. All of this is taken into account by the corresponding settability of the active power control function and the reactive power control function.

An R/X ratio at the grid connection point may likewise form a grid characteristic. Such an R/X ratio is therefore a ratio of the resistance R to the reactance X. This R/X ratio at the grid connection point therefore characterizes the electrical supply grid virtually from the point of view of the grid connection point. This variable is a computational characterization of the electrical supply grid at this grid connection point, but may be clearly explained. The impedance at the grid connection point can be calculated as the quotient of a no-load voltage at the grid connection point to a short-circuit current at the grid connection point. In this respect, the no-load voltage is the voltage which is established, in terms of magnitude and phase, if no current is fed into the electrical supply grid. The short-circuit current is that current which is provided by the electrical supply grid to the grid connection point if there is a short circuit there, that is to say if the infeed unit is not connected at that moment. The impedance Z is therefore characterized or can be represented by the resistance and the reactance. The ratio of resistance to reactance, rather than the absolute values, is important here. The smaller the ratio is again, the greater the phase shift at this grid impedance.

This grid impedance is therefore likewise an operand, but can be clearly explained as the impedance between the grid connection point and an idealized voltage source in the electrical supply grid.

Moreover, the impedance may also be determined without having to carry out a short circuit at the grid connection point. It may also be determined from current changes and resulting voltage changes at the grid connection point in each case.

This R/X ratio is also a grid characteristic since it is not a transient variable and is characterized, in particular, by physical properties of electrical lines in the electrical supply grid and naturally to the grid connection point.

This ratio has been recognized as being important for setting the active power control function and the reactive power control function since it has been recognized that the effectiveness with which the infeed unit can act on the electrical supply grid at the grid connection point may depend on it.

According to one aspect, it is proposed that a grid fault forms a grid state. A grid fault may be, in particular, a short circuit and/or a voltage dip in the electrical supply grid. A voltage dip may be the result of a short circuit in the electrical supply grid but may also have other causes, such as the switching-off of infeed units or the disconnection of a grid section.

A dip to a low voltage, in particular in the range below 20% nominal voltage, comes into consideration as a voltage dip. It has been recognized here, in particular, that, in the event of a grid fault, infeed units may provide specific strategies for how they react to different grid faults. There are sometimes also rules which specify a framework of how infeed units should behave in the event of particular grid faults.

It has therefore been recognized that the result of a grid fault may be that the electrical supply grid behaves differently than if there is no grid fault or a different grid fault and the proposed method can adjust precisely to this if the control functions are set on the basis of a grid fault.

If there is a voltage dip mentioned by way of example, this may result in fundamentally less power being fed into the electrical supply grid. Provision may then be generally made for as much power as possible to be fed in, specifically active power, in order to at least partially compensate for such a deficit. Both frequency-dependent and voltage-dependent active power infeed can then generally be changed such that the active power value to be fed in is at a high level. In particular, in the event of a voltage dip, it may be proposed that a frequency-dependent active power component is reduced to a lesser extent in the case of an overfrequency because, in the event of such a fault, there may be a different dependence between the power requirement or excess and frequency than would be the case in a fault-free situation.

This is only one example and various possible ways of setting the control functions on the basis of a fault come into consideration. For this purpose, it is possible to determine, for different faults, how the infeed units will behave, and the setting of the control functions can be adapted thereto.

According to one aspect, it is proposed that switch positions for setting or adjusting a grid topology form a grid state. This can be combined with a grid fault forming a grid state. Each grid fault may therefore form a grid state and each switch position may likewise form a grid state. The electrical supply grid then has a plurality of grid states which are taken into account.

Such switch positions therefore relate to grid isolating switches in the electrical supply grid which can be opened or closed. Opening such grid isolating switches makes it possible to disconnect grid sections for transmission lines. This may be provided, for example, for maintenance or repair work in order to thereby switch corresponding grid sections to zero potential. However, the fact that specific power flows are intended be changed also comes into consideration.

Changing such switch positions therefore makes it possible to briefly change the behavior of the electrical supply grid. For example, transmission paths between infeed units and loads may be shortened or lengthened. This may accordingly influence a voltage drop between these infeed units and said loads. Accordingly, it is proposed, to remain with this example, to accordingly change a voltage-dependent active power infeed and a reactive power infeed.

However, the fact that the electrical supply grid becomes more or less susceptible to voltage or power fluctuations in the electrical supply grid as a result of such adjustment of the grid topology also comes into consideration. If adjustment of the grid topology therefore results in a weakening of the stability of the electrical supply grid, this can be compensated for by appropriately setting the control functions. If such adjustment of a grid topology results in an electrical supply grid which is prone to oscillate to a greater extent, in particular is prone to power oscillations, this can be counteracted by setting the control functions in such a manner that they exhibit a less attenuating effect, to name a further example.

According to one aspect, it is proposed that a dynamic converter proportion forms a grid state, wherein a dynamic converter proportion describes a ratio of power fed into the electrical supply grid or a grid section thereof by converter-controlled infeed apparatuses to power fed into the electrical supply grid or the grid section overall by all infeed units.

A dynamic converter proportion therefore differs from a static converter proportion. In the case of the dynamic converter proportion, the power which is actually currently being fed in but can change continuously is considered, with the result that the dynamic converter proportion forms a grid state, whereas the static converter proportion forms a grid characteristic.

It is possible to derive, inter alia, from the dynamic converter proportion how the electrical supply grid would react to a fluctuating power requirement of the connected loads. If the dynamic converter proportion is small, that is to say most power is fed in by conventional infeed units, a strong relationship between the fluctuating power requirement and the grid frequency can be assumed. However, if a large amount of power is fed in, in particular predominantly, by converter-controlled infeed units, the result would be a different reaction of the electrical supply grid to the fluctuating power requirement. In particular, a greater dependence of the grid voltage on the fluctuating power requirement can be expected. Accordingly, the control functions can be set in order to comply with these differences.

According to one aspect, it is proposed that one of the two control functions, both control functions or, if at least one of the two control functions is composed of a plurality of control subfunctions, one or more of these control subfunctions are each changed by virtue of the fact that they are each selected from a plurality of predetermined selection control functions. In particular, it is proposed that they are each selected in this case from a set of curves or a set of characteristic areas.

This is based, in particular, on the concept that suitable control functions may be predetermined for different grid states and/or grid characteristics. The fact that such control functions have already been tested in simulations for the corresponding grid states or grid characteristics or at least for similar grid states or grid characteristics also comes into consideration here. In this case, they may also be adapted further so as to be improved even further. Possible grid states and/or grid characteristics may be classified or grouped in order to be able to uniquely assign at least one corresponding selection control function.

However, the fact that a or a respective selection control function is selected for a specific grid state and/or a specific grid characteristic and matches a similar grid state or a similar grid characteristic and is then adapted by means of extrapolation or interpolation also comes into consideration. Two selection control functions are accordingly respectively selected in the case of interpolation. In particular, there are both grid states and grid characteristics, the value of which can be continuously changed. This applies, in particular, to the dynamic converter proportion and to the static converter proportion which may each be provided as percentage values. In this case, selection control functions for dynamic converter proportions and static converter proportions may each be stored in steps of 10%, for example.

Since the control functions, that is to say the active power control function and the reactive power control function, each have a dual dependence, there are various possible ways of implementing them. One possible way involves each control function being composed of two control subfunctions. The active power control function may therefore be composed of two control subfunctions, one of which specifies the active power to be fed in on the basis of the captured grid frequency and the other of which specifies the active power to be fed in on the basis of the captured grid voltage. The active power control function may then be the sum of both control subfunctions.

In this case too, it can then be proposed that the control subfunctions are each selected from a plurality of predetermined selection control functions.

In this case, a selection may then also be made from a set of curves. The selection control function which may form a control subfunction may respectively specify in this respect a characteristic curve which can be represented as a curve. A plurality of selection control functions therefore result in a plurality of characteristic curves, that is to say a plurality of curves, and these curves form a set of curves, from which a selection can be made.

In particular, if the control function, that is to say the active power control function or the reactive power control function, combines its dependence in one function, such a control function may often be represented as a characteristic area. In the case of the active power control function for example, it is thus possible to span an area represented by the active powers to be fed in in each case on the basis of the captured grid frequency and the captured grid voltage. The result is therefore a three-dimensional representation in which the captured grid frequency, the captured grid voltage and the resulting active power to be fed in are plotted in a respective dimension.

The same may also be provided or applicable for the reactive power control function, in which the reactive power to be set is plotted on an axis instead of the active power to be set. This plane accordingly respectively results as a characteristic area. Each of the selection control functions to be predetermined for this purpose then likewise has a dual dependence and can be represented as a characteristic area. This results in a plurality of characteristic areas which together form a set of characteristic areas. As a result, the respective control function can be selected.

According to one configuration, it is proposed that one of the two control functions or at least one of the control subfunctions is changed in a parameterization. A pre-factor may be changed here, in particular. Such a pre-factor may be specified both for a function with simple dependence and for a function with dual dependence. However, a plurality of parameters may also be changed. In the case of a dual dependence in particular, a parameter may be respectively provided for both dependences. If a control function is composed of a plurality of control subfunctions, the change of a parameterization may be provided for each control subfunction. The fact that each control subfunction may have a variable factor also comes into consideration there.

According to one aspect, it is proposed that one of the control functions, both control functions or one or more of the control subfunctions are each changed in a functional characteristic, wherein the functional characteristic may be a width and/or a position of a dead band range of the control function or control subfunction. Additionally or alternatively, the characteristic may be a limit value of the control function or of the control subfunction and/or slope or gradient of the control function or control subfunction.

A control function (the same also applies to a control subfunction) can be characterized by a plurality of functional characteristics. Such characteristics may be, in particular, said characteristics of a dead band range, a limit value and a slope. For these characteristics in particular, it has been recognized that they exhibit different effects depending on at least one grid state and/or at least one grid characteristic.

A dead band range of the control function or the control subfunction is a range in which a change in the input variable(s) does not change the functional value. A characteristic curve or a characteristic area is therefore horizontal in this range. In particular, there is such a dead band range at nominal frequency and/or nominal voltage. If the grid frequency therefore varies within the dead band range around the nominal frequency, this does not affect the output variable, that is to say the active power to be set or the reactive power to be set. The same applies to the grid voltage which can vary in a dead band range around the nominal voltage without the relevant active power or reactive power to be set being changed. Such a dead band range may be defined by a lower frequency value and an upper frequency value or a lower voltage value and an upper voltage value. These values may be changed on the basis of at least one grid state and/or at least one grid characteristic, in particular in such a manner that their distance from one another is changed. However, the fact that they are changed in such a manner that the position of the dead band range is shifted, which can be carried out with or without a change in the width of the dead band range, also comes into consideration.

In particular, it has been recognized that the dead band range can be selected to be large in the case of a small static converter proportion and a small dynamic converter proportion. This is specifically based on the finding that the conventional infeed units are then dominant and result in stabilization of the electrical supply grid, but minor fluctuations both of the grid frequency and of the grid voltage may occur. The dead band range can be adapted to such expected and permissible fluctuation ranges and, as a result, stabilization is normally left to these conventional infeed units.

Only if such a dead band range is exceeded is it useful to intervene according to the proposed method by means of converter-controlled infeed units. However, if the static converter proportion or the dynamic converter proportion is large, such a stabilizing behavior is accordingly present to a lesser extent. It may then be useful, even in the case of minor deviations, to intervene in a stabilizing manner, specifically in order to assume the missing or reduced stabilizing effect of the conventional infeed apparatuses. Therefore, a comparatively low dead band range is proposed, in particular, in the case of a high static and/or high dynamic converter proportion.

It may be useful to shift the dead band range if the grid frequency or the grid voltage is intended to be brought to a value other than the nominal frequency or nominal voltage. A shift of the dead band range also comes into consideration when the electrical supply grid discernibly and/or predictably strives for a voltage value other than the nominal voltage or strives for a grid frequency value other than the nominal frequency. If the electrical supply grid strives for a higher value which is therefore above the nominal frequency or nominal voltage, for example, it may be advantageous to accordingly shift the dead band range to a lower value, which means, in particular, that an average value of the respective dead band range is brought to the relevant lower value.

If the control function has a dual dependence, with the result that it can be represented as a characteristic area, an accordingly two-dimensional dead band range may also be provided, that is to say a plateau which extends in the direction of the grid frequency, on the one hand, and extends in the direction of the grid voltage, on the other hand. Accordingly, such a dead band range may form a dead area and may therefore also have two widths, that is to say a width in two directions in each case. Both widths may be set on the basis of at least one grid state and/or at least one grid characteristic. The position of such a dead area, in particular a center point of such a dead area, may also be changed on the basis of at least one grid state and/or at least one grid characteristic.

Since an infeed unit cannot feed in any desired amount of active or reactive power, limit values may be provided for the control function or control subfunction, at least one limit value for each function. However, such limit values may often not only stipulate the corresponding limit so that it is complied with, but rather such a limit value often also forms a corner point of a control function or control subfunction. Therefore, setting a limit value also makes it possible to change the control function or control subfunction in another manner.

In particular, it has been recognized that, when there is a grid fault, limit values should be reached as quickly as possible in order to handle this grid fault as effectively as possible. In this case, it has also been recognized that grid faults are usually only of a very short duration, and budgeting with the power which can be fed in—this applies, in particular, to the active power and to a slight extent also to the reactive power—is therefore not really necessary. It has also been recognized that limit values are easily reached anyway in the event of grid faults and, in this respect, a function profile before a limit or between limits is scarcely relevant.

It has likewise been recognized, to name a further example, that a very large amount of power is fed in by converter-controlled infeed units in the case of a high dynamic converter proportion and all of these converter-controlled infeed units can therefore form a large control potential. In that case, a low limit value or a limit value which results in flat function profiles may be sufficient. It has been recognized that, in terms of the issue of whether a flatter profile is sufficient, it also comes into consideration that there could be overcompensation of effects if a large number of converter-controlled infeed units simultaneously increase the active power which is fed in according to the same or a similar function, for example.

On the basis of a static converter proportion, it is proposed, in particular, to set a lower limit value, in particular for the active power control function. In particular, the magnitude of said limit value can be selected to be particularly large or, in absolute terms, particularly small if the static converter proportion is large. It has been recognized here, in particular, that a power drain can be controlled thereby. However, a potential for a power drain may also be performed by converter-controlled infeed units which currently are not feeding in very much power or no power at all. Therefore, the static converter proportion, in particular, is relevant here.

It is likewise proposed to provide large limits for the reactive power control function, in particular in terms of magnitude, if the static converter proportion is large and the dynamic converter proportion is small. It has been recognized here, in particular, that the feeding in or removal of reactive power does not depend or depends only to a slight extent on available active power, and a high static converter proportion therefore already results in a large amount of reactive power being able to be fed in or removed by the converter-controlled infeed units. Active power which is fed in may even be detrimental in this case because converter-controlled infeed units must also take into account an apparent current limit when feeding in power. If a large amount of active power has already been fed in, a large part of the apparent current limit may have already been exhausted. The active power which is fed in would then have to be reduced in order to provide more potential for feeding in or removing a high reactive power. Although such a reduction is possible, it is undesirable. However, if the active power fed in by converter-controlled infeed apparatuses is low anyway, which may be the case with a small dynamic converter proportion, the potential for feeding in or removing reactive power may be fully exhausted.

A gradient or a slope of the control function or the control subfunction may also determine the extent to which the relevant function reacts to frequency changes or voltage changes. In this case, such a gradient or slope may act like or characterize a control gain. A gradient is relevant, in particular, when the active power control function and the reactive power control function take their dual dependence into account overall and the respective control function can be described by a characteristic area. The largest incline or the largest slope of at least one characteristic point of the characteristic area forms the gradient. In this case, the gradient indicates the magnitude and direction of the slope or the incline. At least the gradient with the largest magnitude of all points of the characteristic area is preferably considered and changed.

If the active power control function and/or the reactive power control function is/are composed of control subfunctions, the latter may be represented as a characteristic curve and characterized by a slope. The largest slope can also be used here. However, such a characteristic curve often has only one slope. In particular, it is possible to provide a characteristic curve having two sections with a linear and identical slope, interrupted by a dead band range. In addition, the characteristic curve is limited by an upper and a lower limit value.

It has also been recognized here that a gain of the control function or control subfunction may be respectively set by means of this gradient or the slope. It is therefore also possible here to use the considerations that a smaller slope or a smaller gradient should rather be provided in the case of a large dynamic converter proportion. In the event of a fault, larger gradients or slopes may be provided, in particular.

According to one aspect, it is proposed that one or both control functions or one or more control subfunctions are variable by means of a weighting, wherein the weighting is in the form of a weighting factor, in particular, and that the respective control function or control subfunction is set by setting its weighting. Advantages of a weighting have already been explained above. Forming the weighting as a weighting factor is a simple and nevertheless effective possible way of setting both a control function with a multiple dependence and a control subfunction with a simple dependence. A gain can also be set thereby, in particular.

In particular, the dead range, in any case the width of the dead range, does not change as a result of the weighting. The slope and therefore gain can therefore be changed by the weighting, in particular if it is in the form of a weighting factor, without otherwise changing the control function or control subfunction. The above explanations with respect to the choice of slopes and therefore controller gains are therefore likewise applicable here.

However, a weighting function which can result in a non-linear change in the control function or control subfunction may also be fundamentally provided as the weighting. This may be useful, for example, in order to take limit values into account. If a control function thus extends from −100% to +100%, for example, and is multiplied by a weighting factor of 2, that is to say is weighted, the result would extend from −200% to +200%, although only −100% and +100% would be able to be implemented. Provision may be made to use a weighting function which has at most the value 1 in the edge region or another value which prevents a realistic limit from being exceeded.

However, provision is made, in particular, for control subfunctions to be weighted differently.

According to one aspect, it is proposed that the active power control function is implemented by means of an active power frequency function which forms a control subfunction and indicates a relationship between the captured grid frequency and a first active power value, and an active power voltage function which forms a control subfunction and indicates a relationship between the captured grid voltage and a second active power value. The additional active power is determined on the basis of the first and second active power values, in particular from a sum of the first and second active power values. It is also proposed in this respect that the active power frequency function can be set by means of an active power frequency weighting, and the active power voltage function can be set by means of an active power voltage weighting. In order to change these two control subfunctions, the active power frequency weighting and the active power voltage weighting, or at least one of them, is/are changed in such a manner that an active power weighting quotient which changes a quotient between the active power frequency weighting and the active power voltage weighting is changed.

Provision is therefore made here for the active power control function to be composed of two control subfunctions, specifically the active power frequency function and the active power voltage function. The additional active power then results from the sum of the first and second active power values, that is to say the result of the sum of the two control subfunctions. However, the fact that further active power values, which possibly result on the basis of yet further input variables, may be included also comes into consideration. Therefore, the additional active power need not be exclusively composed of the sum of the first and second active power values. However, the fundamental consideration in this case is that these are the important influencing variables for calculating the additional active power.

In order to adapt a dependence of the additional active power on the captured grid frequency and the captured grid voltage to the respective grid situation, two weightings are provided here and are in the form of two factors, in particular. As a result, it is possible to set, in particular, a different influence of the captured grid frequency, on the one hand, and of the captured grid voltage, on the other hand. As a result, it is possible to change between two different influences of these two input variables which are to be provided. Depending on the grid situation, the influence of the captured grid frequency or the influence of the captured grid voltage may be higher or even dominant, or both influences may be approximately the same. The grid situation is taken into account here, in particular, by means of at least one grid state and/or at least one grid characteristic.

The active power frequency weighting and the active power voltage weighting are accordingly provided. These two weightings may be changed, and an active power weighting quotient is also changed thereby. This active power weighting quotient therefore indicates how strong the division of the influence of the captured grid frequency, on the one hand, and the captured grid voltage, on the one hand, on the additional active power is.

This influence may therefore be changed in the simplest manner by influencing each of these two control subfunctions, that is to say the active power frequency function and the active power voltage function, by means of their own weighting, specifically by means of the active power frequency weighting and the active power voltage weighting. Other implementations may of course also come into consideration in the technical implementation. For example, a weighting may be provided only for one of the two control subfunctions, but it is possible to additionally provide an overall weighting function which weights or scales the sum of the two control functions or the sum of the first and second active power values. The result is the same or may be readily converted into one another. However, the underlying idea may best be shown with the aid of the two individual weightings explained, that is to say the active power frequency weighting and the active power voltage weighting.

Provision is therefore made, in particular, for one weighting to be increased and the other weighting to be decreased in the event of a change from one grid situation to another. In simple terms, the influences of the captured grid frequency and the captured grid voltage on the additional active power are the same if the active power weighting quotient is 1. However, this serves only for illustration and the influence also ultimately depends on the respective control subfunctions or their scaling.

According to one aspect, it is proposed that the reactive power control function is implemented by means of a reactive power frequency function which forms a control subfunction and indicates a relationship between the captured grid frequency and a first reactive power value, and a reactive power voltage function which forms a control subfunction and indicates a relationship between the captured grid voltage and a second reactive power value. The additional reactive power is determined on the basis of the first and second reactive power values, in particular from a sum of the first and second reactive power values. In this respect, it is proposed that the reactive power frequency function can be set by means of a reactive power frequency weighting, and the reactive power voltage function can be set by means of a reactive power voltage weighting. In order to change these two control functions, the reactive power frequency weighting and the reactive power voltage weighting, or at least one of them, is/are changed in such a manner that a reactive power weighting quotient which changes a quotient between the reactive power frequency weighting and the reactive power voltage weighting is changed.

For the reactive power control function, it is therefore proposed here to implement the latter by means of a reactive power frequency function and a reactive power voltage function which each form a control subfunction. In particular, a linear superimposition of these two control subfunctions may be provided here. Such a linear superimposition may moreover also be provided for the above-described composition of the active power control function from the active power frequency function and the active power voltage function.

The same procedure as that for the active power control function composed of an active power frequency function and an active power voltage function is actually analogously provided here for the reactive power control function composed in this manner of the two control subfunctions. The explanations with respect to the active power control function composed in this manner likewise analogously apply here to the composed reactive power control function.

Therefore, for the reactive power control function too, it is easily possible to vary said function on the basis of the captured grid frequency and on the basis of the captured grid voltage. Depending on the grid situation, this makes it possible to achieve a greater influence of the captured grid frequency or a greater influence of the captured grid voltage on the reactive power control function or on the additional reactive power. A smooth transition can also be achieved here by appropriately selecting or changing the reactive power frequency weighting and the reactive power voltage weighting.

According to one aspect, it is proposed that, with an increasing static converter proportion and/or with an increasing dynamic converter proportion, control subfunctions are changed in such a manner that the active power weighting quotient falls, and/or the reactive power weighting quotient increases. Additionally or alternatively, it is proposed that the magnitude of an active power ratio, which describes a ratio of an average normalized slope of the active power frequency function to an average normalized slope of the active power voltage function, falls. Additionally or alternatively, it is proposed that the magnitude of a reactive power ratio, which describes a ratio of an average normalized slope of the reactive power frequency function to the normalized reactive power voltage function, increases.

It is therefore proposed, in particular, that the active power weighting quotient falls with an increasing static converter proportion and/or with an increasing dynamic converter proportion. The fact that the active power weighting quotient falls means that a frequency-dependent proportion of the additional active power becomes smaller and a voltage-dependent proportion of the additional active power increases. The influence of the captured voltage on the additional active power therefore becomes greater with an increasing static converter proportion and/or with an increasing dynamic converter proportion.

It has been recognized here, in particular, that a power balance in the electrical supply grid has a lesser effect on the grid frequency, the smaller the proportion of conventional infeed units (e.g., conventional generators or power plants) in the electrical supply grid. This knowledge is therefore implemented here.

Additionally or alternatively, it is proposed to change control subfunctions in such a manner that the reactive power weighting quotient likewise increases with an increasing static converter proportion and/or with an increasing dynamic converter proportion. For the additional reactive power, the dependence on the grid frequency therefore then increases. It has also been recognized here that a coupling between the reactive power and the frequency can increase and a coupling between the reactive power and the voltage can decrease, at least can comparatively decrease, with a falling proportion of conventional infeed units in the electrical supply grid. This is taken into account by appropriately setting the control subfunctions.

Additionally or alternatively, it is proposed to change control subfunctions in such a manner that an active power ratio, which describes the ratio of a normalized active power frequency function to a normalized active power voltage function, falls. The active power ratio is very similar to the active power weighting quotient. However, the active power ratio can be fundamentally changed without using weightings. For example, the two control subfunctions, that is to say the active power frequency function and the active power voltage function, can be changed in another manner, for example by selecting in each case a different active power frequency function or active power voltage function from a plurality of selection control functions.

In this case, the active power ratio is a ratio, that is to say quotient, of the slope of the active power frequency function to the slope of the active power voltage function. It is assumed here, in particular, that an active power ratio describes a ratio of an average normalized slope of the active power frequency function to an average normalized slope of the active power voltage function. It is assumed here, in principle, that both the active power frequency function and the active power voltage function have only one slope. These two slopes are compared with one another by relating them to one another. However, the magnitude, rather than the absolute value, is considered for assessment, which plays a role when such a quotient results in a negative value.

However, if there are a plurality of slopes in a function, an average slope is considered. In this case, horizontal regions are not taken into account. A dead band range is therefore not taken into account and a plateau above an upper limit value or below a lower limit value is not taken into account either.

Since the slopes, from which a ratio is formed here, have different physical units and therefore cannot be directly compared, a normalization is respectively proposed, which is explained below.

A falling active power ratio therefore has a similar or even identical significance to a falling active power weighting quotient.

In this sense, a reactive power ratio is also proposed as an assessment measure. Like the reactive power weighting quotient, it is likewise intended to increase with an increasing static converter proportion and/or with an increasing dynamic converter proportion. It therefore reflects a similar or identical relationship, but does not require the use of a weighting function, but does not exclude this either. Otherwise, the explanations with respect to the active power ratio also analogously apply to the reactive power ratio.

According to one aspect, it is proposed that the active power ratio describes a ratio of an average normalized slope of the active power frequency function to an average normalized slope of the active power voltage function. In this case, the slope of the active power frequency function is normalized to a quotient of a nominal power of the infeed unit to a maximum permissible frequency deviation of the grid frequency from the nominal frequency, and the slope of the active power voltage function is normalized to a quotient of the nominal power of the infeed unit to a maximum permissible voltage deviation of the grid voltage from the nominal voltage. It is proposed in this respect that the magnitude of the active power ratio falls with an increasing static converter proportion and/or with an increasing dynamic converter proportion and has a value of less than 1 if the static converter proportion and/or the dynamic converter proportion reach(es) or exceed(s) 80%.

A specific normalization is therefore proposed for the slope of the active power frequency function and for the scope of the active power voltage function in order to also enable a quantitative assessment. The normalization of the slope is respectively based on a quotient of the nominal power of the infeed unit to a maximum permissible deviation, specifically a maximum permissible frequency deviation in one case and a maximum permissible voltage deviation in the other case. The two control subfunctions, that is to say the active power frequency function and the active power voltage function, are fundamentally also defined only in this range since, if the maximum deviations are exceeded, the infeed units must often be disconnected from the grid. At the same time, the amplitude, that is to say the additional active power, can reach the nominal power and therefore a limit of the infeed unit. This usually also applies to the negative value, that is to say the active power which can be taken from the grid. No more active power can usually be taken from the electrical supply grid either since otherwise a permissible apparent current limit would be exceeded. The normalization therefore normalizes—in simple terms—the respective slope to the maximum definition range of the respective control subfunction.

These two slopes can therefore be compared and the ratio of these two slopes, that is to say the active power ratio, is then 1, in each case in terms of magnitude, if both slopes normalized in this manner are the same, in terms of magnitude. If the value is less than 1, this means the slope of the active power on the basis of the frequency is lower than the slope of the active power on the basis of the voltage. Precisely this is required if the static converter proportion and/or the dynamic converter proportion reach(es) or exceed(s) the value of 80%. It is therefore proposed when there is a comparatively small proportion of conventional infeed units in the electrical supply grid.

It has been recognized here, in particular, that, above such a value of 80%, the influence of conventional infeed units has become so low that the frequency-dependent active power slope may be smaller than the voltage-dependent active power slope.

It has therefore been recognized that the coupling between the active power and the voltage can be assumed to be greater here than the coupling between the active power and the frequency.

Additionally or alternatively, it is proposed that the reactive power ratio describes a ratio of an average normalized slope of the reactive power frequency function to a normalized reactive power voltage function, wherein the slope of the reactive power frequency function is normalized to a quotient of a nominal power of the infeed unit to a maximum permissible frequency deviation of the grid frequency from the nominal frequency. For this purpose, the slope of the reactive power voltage function is normalized to a quotient of a nominal power of the infeed unit to a maximum permissible voltage deviation of the grid voltage from the nominal voltage. In this respect, it is proposed that the magnitude of the reactive power ratio increases with an increasing static converter proportion and/or with an increasing dynamic converter proportion and has a value of greater than 1 if the static converter proportion and/or the dynamic converter proportion reach(es) or exceed(s) 80%.

In a similar manner to that explained for the active power ratio, which can be quantitatively assessed by specifically normalizing the two compared slopes, this is also proposed here for the reactive power ratio. The normalization is based on similar concepts, specifically taking the range of the respective control subfunction as a basis, which may also be meaningfully only included.

In this case, the use of the nominal power, that is to say the nominal active power, of the infeed unit is also useful for standardizing the reactive power slope since, despite a different significance of the reactive power, on the one hand, and the active power, on the other hand, the already mentioned limitation to an apparent current limit results in the same variable for the reactive power.

The reactive power ratio is therefore a ratio of the frequency-dependent reactive power slope to the voltage-dependent reactive power slope. This ratio becomes greater than 1 if the frequency-dependent reactive power slope is greater than the voltage-dependent reactive power slope. Such a ratio of >1 is proposed when the static converter proportion and/or the dynamic converter proportion has/have reached or exceed(s) 80%. This is also based on the concept that, above this 80%, the proportion of conventional infeed units has become so small that a greater coupling between the reactive power and the frequency than between the reactive power and the voltage can be expected. It is therefore proposed to appropriately select or set the reactive power frequency function and the reactive power voltage function.

Provided is an infeed unit for exchanging electrical power between the infeed unit and an electrical supply grid at a grid connection point. In particular, the infeed unit is in the form of a wind power installation or a wind farm having a plurality of wind power installations. The electrical supply grid, to which the infeed unit is connected via the grid connection point, has a variable grid voltage and a variable grid frequency and is characterized by a nominal voltage and a nominal frequency.

The infeed unit is also prepared to control the exchange in such a manner that the exchange of electrical power comprises exchanging active and reactive power, and the exchange of the active power is controlled on the basis of a frequency-dependent and voltage-dependent active power control function, wherein the active power control function specifies an additional active power to be fed in in addition to an active power basic value on the basis of the captured grid frequency and on the basis of the captured grid voltage.

The infeed unit is also prepared such that the exchange of the reactive power is controlled on the basis of a frequency-dependent and voltage-dependent reactive power control function, wherein the reactive power control function specifies an additional reactive power to be fed in in addition to a reactive power basic value on the basis of the captured grid frequency and on the basis of the captured grid voltage. The infeed unit is likewise prepared to control the feeding-in operation in such a manner that the active power control function and the reactive power control function respectively form a control function and are set on the basis of at least one grid characteristic and/or at least one grid state of the electrical supply grid.

In particular, such a method is implemented in the infeed unit, for example with the aid of a control unit (e.g., controller) and/or a process computer. In particular, the infeed unit is in the form of a converter-controlled infeed unit and therefore uses a converter, which can also use an inverter or can be part of an inverter, in order to feed electrical power into the electrical supply grid. Electrical power can also be removed from the electrical supply grid by means of such a converter.

There are also appropriate interfaces and/or appropriate sensors in order to capture the variables of the electrical supply grid which are used, in particular in order to capture the grid voltage and the grid frequency. Further interfaces and/or sensors are also provided in order to capture the at least one grid state and/or to determine the at least one grid characteristic. A communication interface may be provided, in particular, for determining a grid characteristic and/or a grid state and can be used to receive information relating to the at least one grid state and/or the at least one grid characteristic from the outside. Depending on the grid characteristic to be captured and/or the grid state to be captured, measured values of the current, voltage and/or power fed in may also be evaluated in order to calculate the required information therefrom.

In particular, the exchange of the active power and the reactive power can be controlled in such a manner that a target value is respectively determined for the active power to be fed in or removed and a target value is determined for the reactive power to be fed in or removed. These target values can be transmitted to the respective converter unit (e.g., converter) which then feeds in or removes the active and reactive power on the basis thereof. In particular, the magnitude and phase of a current to be fed in may be specified to the converter unit for this purpose.

According to one aspect, it is proposed that the infeed unit is configured to carry out a method according to one of the embodiments described above. Additionally or alternatively, provision is made for the infeed unit to have a converter unit for exchanging electrical power with the electrical supply grid and for the infeed unit to have at least one control unit which is respectively configured to control the converter unit or one of the converter units, wherein a controller for controlling a method according to one of the embodiments described above is implemented on the at least one control unit.

In particular, it is possible to provide a single control unit and a single converter unit if the infeed unit is only a wind power installation. If the infeed unit is in the form of a wind farm having a plurality of wind power installations, this wind farm may also have a common converter unit for all wind power installations and it is possible to provide a control unit which controls this one converter unit.

However, in a wind farm, each individual wind power installation is preferably equipped with a control unit and a converter unit. If appropriate, a central control unit (e.g., central controller) for specifying and coordinating target values for all wind power installations may also be additionally provided.

The proposed method can be individually implemented on each wind power installation. The corresponding control functions or control subfunctions are then naturally adapted, in particular in terms of their level, to the corresponding wind power installation, specifically to its nominal power, in particular. The result is then nevertheless an overall behavior for the wind farm in which the behavior of the individual wind power installations is specifically superimposed.

### BRIEF DESCRIPTION OF THE SEVERAL VIEWS OF THE DRAWINGS

The invention is explained in more detail below by way of example on the basis of embodiments with reference to the accompanying figures:

FIG. 1 shows a perspective illustration of a wind power installation.

FIG. 2 shows a schematic illustration of a wind farm.

FIG. 3 shows a schematic control structure for carrying out a proposed method.

FIG. 4A shows a control subfunction for determining an additional active power.

FIG. 4B shows a control subfunction for determining an additional active power.

FIG. 5A shows a control subfunction for determining an additional reactive power.

FIG. 5B shows a control subfunction for determining an additional reactive power.

FIG. 6 shows a simplified illustration of a generalized grid section of an electrical supply grid.

### DETAILED DESCRIPTION

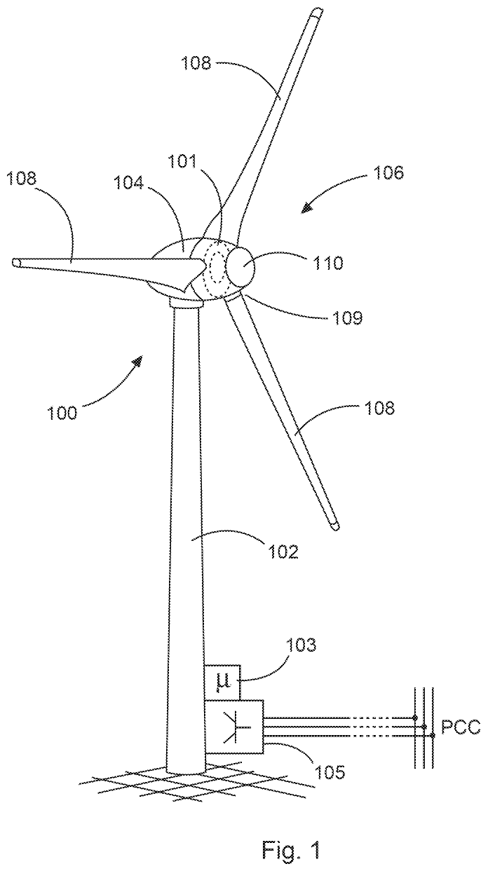

FIG. 1 shows a perspective illustration of a wind power installation. The wind power installation 100 has a tower 102 and a nacelle 104 on the tower 102. An aerodynamic rotor 106 having three rotor blades 108 and spinner 110 is provided on the nacelle 104. The aerodynamic rotor 106 is caused to rotate by the wind during operation of the wind power installation and therefore also rotates an electrodynamic rotor of a generator which is directly or indirectly coupled to the aerodynamic rotor 106. The electrical generator is arranged in the nacelle 104 and generates electrical energy. The pitch angles of the rotor blades 108 can be changed by means of pitch motors on the rotor blade roots 109 of the respective rotor blades 108.

In this case, the wind power installation 100 has an electrical generator 101 which is indicated in the nacelle 104. The generator 101 can be used to generate electrical power. In order to feed in electrical power, provision is made of an infeed unit (infeed device) 105 which may be in the form of an inverter, in particular. A three-phase infeed current and/or a three-phase infeed voltage can therefore be generated according to amplitude, frequency and phase for feeding in at a grid connection point PCC. This may be carried out directly or together with further wind power installations in a wind farm. An installation controller 103 is provided for the purpose of controlling the wind power installation 100 and also the infeed unit 105. The installation controller 103 may also receive specified values from the outside, in particular from a central farm computer.

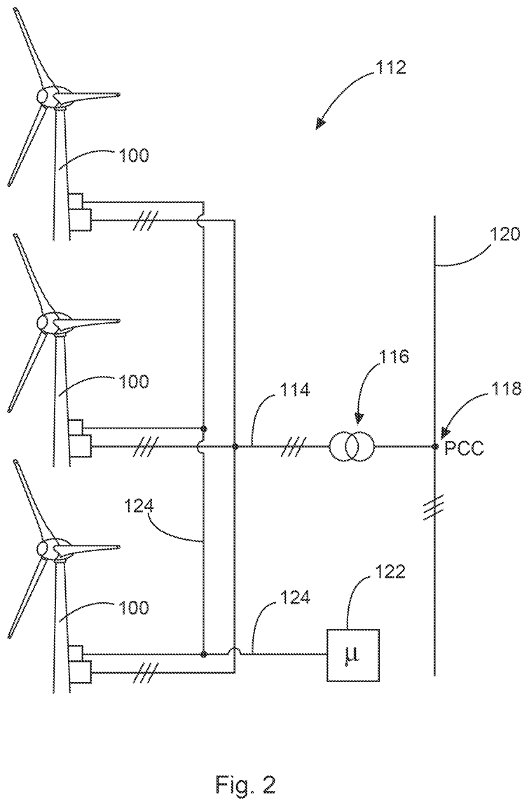

FIG. 2 shows a wind farm 112 having, by way of example, three wind power installations 100 which may be identical or different. The three wind power installations 100 are therefore representative of fundamentally any desired number of wind power installations in a wind farm 112. The wind power installations 100 provide their power, specifically in particular the generated current, via an electrical farm grid 114. In this case, the respectively generated currents or powers of the individual wind power installations 100 are added and are fed into the supply grid 120 at the infeed point 118, which is also generally referred to as the PCC. A transformer 116 is usually provided and steps up the voltage in the farm at the infeed point 118. FIG. 2 is only a simplified illustration of a wind farm 112. The farm grid 114, for example, may have a different configuration by virtue of there also being a transformer, for example, at the output of each wind power installation 100, to name just one other exemplary embodiment.

The wind farm 112 also has a central farm computer 122 which can synonymously also be referred to as a central farm controller. It can be connected to the wind power installations 100 via data lines 124, or in a wireless manner, in order to thereby interchange data with the wind power installations and, in particular, to receive measured values from the wind power installations 100 and to transmit control values to the wind power installations 100.

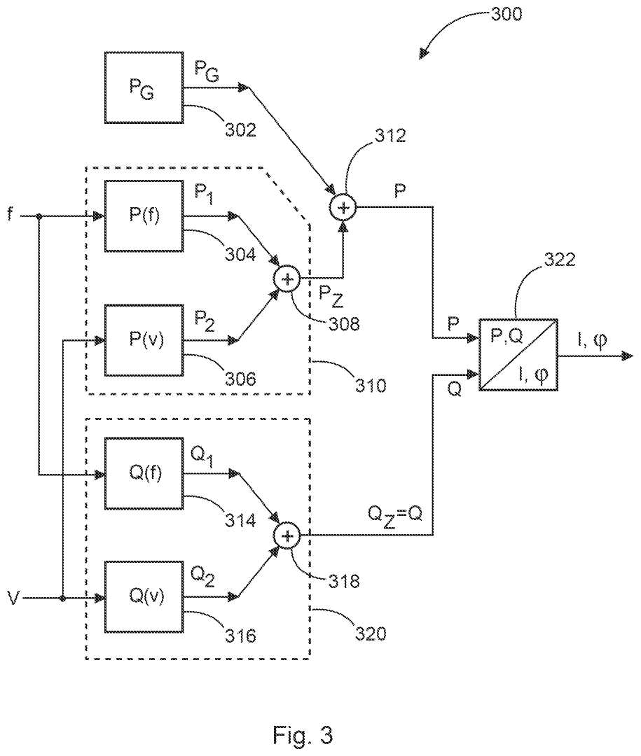

FIG. 3 shows a control structure for controlling, in particular specifying, power to be exchanged with the electrical supply grid. The control structure (e.g., controller) 300 exhibits a power specification block 302 which specifies an active power basic value PG. This can be effected in response to a request and/or on the basis of available power. If it is effected on the basis of available power, specifically wind power, in particular in the case of wind power installations, this need not mean that the active power value PG corresponds to the maximum available power at that moment. The value may also be selected to be lower in order to specifically provide potential room for action for further power components. Furthermore, provision is made of an active power frequency block 304 which comprises an active power frequency function P(f) in order to determine a first active power value P₁ on the basis of the captured grid frequency f.

Provision is also made of an active power voltage block 306 which comprises an active power voltage function P(V) in order to determine a second active power value P₂ on the basis of the captured grid voltage V. The first active power value and the second active power value are then added at the first summation point 308 to form an additional active power P_{z} to be additionally fed in.

That active power frequency block 304 and the active power voltage block 306, together with the second summation point 308, therefore implement an active power control function. The three elements mentioned can therefore be combined to form an active power control block 310. Accordingly, the active power control block 310 is illustrated as a dashed block which combines the three elements mentioned.

The active power control block 310 therefore outputs the additional active power P_{z} on the basis of the captured grid frequency f and the captured grid voltage v. This is added to the active power basic value P_{G} at the second summation point 312, thus resulting in the active power P to be fed in overall.

The procedure is very similar for taking the reactive power into account. Provision is made here of a reactive power frequency block 314 which comprises a reactive power frequency function. It therefore determines a first reactive power value Q₁ on the basis of the captured grid frequency f. A reactive power voltage block 316 determines a second reactive power value Q₂ on the basis of the captured grid frequency. For this purpose, the reactive power voltage block 316 comprises a reactive power voltage function. The first and second reactive power values Q₁ and Q₂ are added at the third summation point 318 to form the additional reactive power Q_{z}.

The reactive power frequency block 314, the reactive power voltage block 316 and the third summation point 318 can therefore be logically combined to form a reactive power control block 320. The reactive power control block therefore implements the method of operation of a reactive power control function.

For the reactive power, provision is often not made for a reactive power basic value that differs from 0 to actually exist or to be additionally specified. Therefore, no equivalent to the power specification block 302 for the active power is provided here for the reactive power. However, such a block may nevertheless be provided if a reactive power basic value is additionally intended to be specified. This could then be added to the additional reactive power value Q_{z}. However, if such a reactive power basic value is not available, as in the variant shown in FIG. 3, the additional reactive power Q_{z} corresponds to the reactive power Q to be fed in or exchanged.

The active power P to be fed in and the reactive power Q to be fed in are then transformed or converted into a current Ito be fed in in the conversion block 322. In this case, the current Ito be fed in is characterized by its amplitude and additionally by its phase angle φ. Accordingly, the result from the conversion block 322 is a current to be fed in according to amplitude I and phase φ. This result can be passed to a converter which generates a corresponding current according to magnitude and phase and feeds it into or takes it from the electrical supply grid.

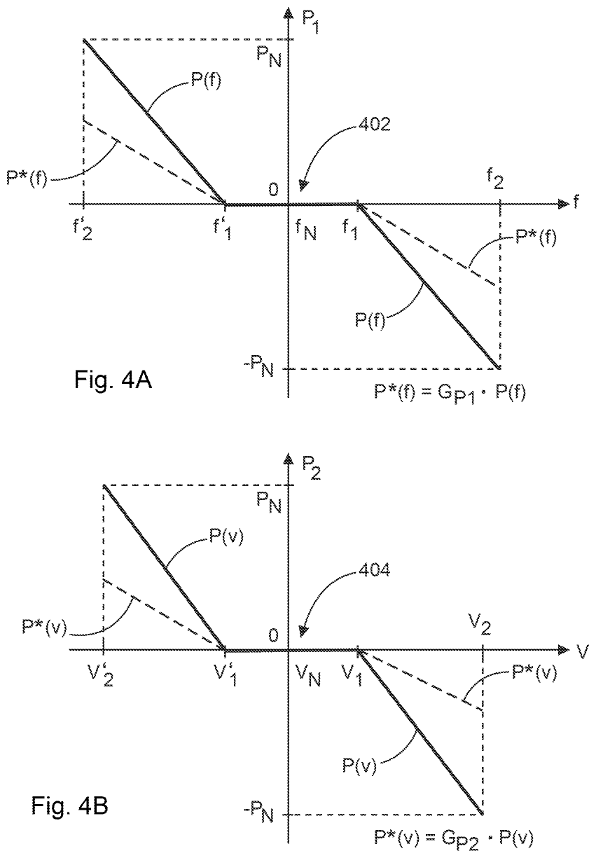

FIG. 4A shows an example active power frequency function. FIG. 4A shows an example active power voltage function. FIG. 4A represents an active power frequency function P(f). It indicates a relationship between the captured grid frequency f and a first active power value P₁. At the origin of the representation, the first active power value is 0 and the frequency f is nominal frequency f_{N}. There is also a dead band range there between the frequency values f′₁ and f₁. This dead band range 402 can be changed, both in terms of its width and in terms of its position, by changing the frequency values f′₁ and f₁. However, the dead band range 402 is often symmetrical with respect to the origin, that is to say with respect to the nominal frequency f_{N}.

Otherwise, this active power frequency function P(f) at the lowermost frequency f′₂ falls continuously from the nominal power value P_{N} to 0 at the lower dead band frequency f_{1′}. After the dead band range 402, the active power frequency function P(f) falls to the value −P_{N}, specifically from the upper dead band frequency f₁ to the uppermost frequency f₂.

The active power frequency function P(f) shown can be considered to be a basic function which can be weighted for use. In particular, it can be weighted, for weighting, with an active power frequency weighting G_{P1} which is provided here as a factor. The result is then a modified active power frequency function P*(f) which is illustrated using dashed lines in FIG. 4A. There is no difference in the dead band range 402.

In the illustration of FIG. 4A, the weighting factor approximately has the value 0.5 (G_{P1}=0.5).

FIG. 4B illustrates an active power voltage function P(V). The active power voltage function P(V) likewise has a dead band range 404. The latter is between the lower dead band voltage V′₁ and the upper dead band voltage V₁. Otherwise, the active power voltage function P(V) is such that it falls from the lowermost voltage V′₂ at nominal power P_{N} to 0 at the lower dead band voltage V′₁. From the upper dead band voltage V₁, it falls further to the uppermost voltage V₂ at negative nominal power −P_{N}.

In this case too, the active power voltage function P(V) is intended to form a basic function which is also intended to be weighted with an active power voltage weighting which is also implemented here as a weighting factor G_{P2}. Accordingly, the result is the modified active power voltage function P*(V).

In this case too, the weighting factor P_{P2} approximately has the value 0.5, which results in a flattening of the modified active power voltage function P*(V) with respect to the unmodified active power voltage function P(V).

An approach has been proposed here in which both the unmodified active power frequency function P(f) and the unmodified active power voltage function P(V) have been selected to have a maximum value, specifically such that they extend to the nominal power P_{N} and to the negative value of the nominal power −P_{N}. For use, they can be multiplied by the respective weighting factor which is proposed here to be a value between 0 and 1.

In particular, it is proposed that the active power frequency weighting factor G_{P1} and the active power voltage weighting factor G_{P2} in total result in a maximum of 1. The reason for this can be explained on the basis of the comparison of FIGS. 4A and 4B.

As a result of the fact that both functions are multiplied by a weighting factor of <1, both functions are flattened. As a result of the fact that the sum of the two weighting functions should not exceed the value 1, at most the value of the nominal power P_{N} also results, in terms of magnitude, during the sum of the functions. It naturally also comes into consideration that even reaching nominal power is not desirable, in particular because the additional active power P determined thereby is also intended to be added to an active power basic value PG, as can be gathered from the control structure 300 in FIG. 3. Accordingly, the weightings can be selected in such a manner that in total they are below, in particular considerably below, the value 1.

It can likewise be discerned that the corresponding function or the characteristic curve illustrated therefor in the graph becomes flatter, that is to say its slope falls, as a result of the multiplication by the respective weighting factor. For the example illustrated in Figures A and 4B4, the two weighting factors G_{P1} and G_{P2} are intended to be the same, specifically 0.5. Accordingly, the two modified functions, that is to say the modified active power frequency function P*(f) and the modified active power voltage function P*(V), are also flatter and have a flatter slope. They have the same slope, at least according to the selected representation. Since, apart from the respective dead band range, only one slope is present here, this slope is also simultaneously the average slope in each case.

In order to now assess the weighting, a quotient of these two slopes may be formed and, since they are the same in the selected example in FIGS. 4A and 4B, this quotient has a factor of 1. The two weighting factors are likewise the same and their quotient is likewise 1. The ratio of the two weighting factors and the ratio of the two slopes can therefore lead to the same or a similar result. If the functions were more complex, differences could naturally arise.

In any case, the same values are selected here for the two weighting factors and the two functions have the same slopes and this is proposed, according to one embodiment, for a small proportion of conventional infeed units in the electrical supply grid. It is also proposed, in particular, if the static converter proportion and/or the dynamic converter proportion is/are at least 80%.

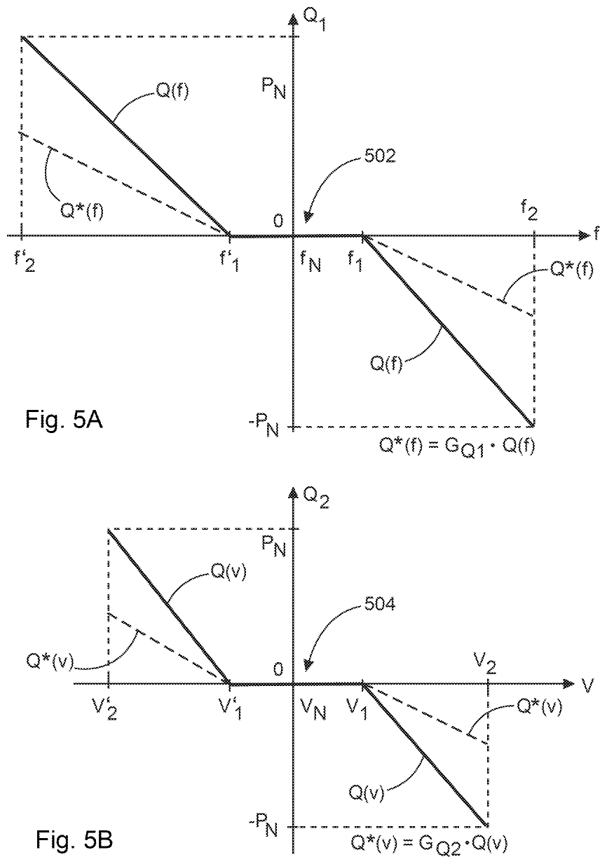

FIGS. 5A and 5B correspond to FIGS. 4A and 4B, but functions for the reactive power are shown. Therefore, FIG. 5A shows a reactive power frequency function Q(f) and FIG. 5B shows a reactive power voltage function Q(V). The amplitudes are also here each normalized to nominal power P_{N}, as in FIGS. 4A and 4B. In physical terms, although the unit for reactive power Q differs from the unit for active power P, the value of the nominal power P_{N} can nevertheless also be used to normalize the reactive power functions Q(f) and Q(V).

In FIG. 5A, the same values as in FIG. 4A have been selected as frequency values, specifically a lowermost frequency f′₂, a lower dead band frequency f′₁, an upper dead band frequency f₁ and an uppermost frequency f₂. A dead band range 502 is likewise provided and the reactive power frequency function Q(f) therefore respectively indicates a first reactive power value Q₁ on the basis of the captured grid frequency f. The profiles likewise analogously correspond to the active power frequency function P(f) in FIG. 4A. However, they may also be different and other frequency values may also be used. However, it is preferably proposed to use similar or analogously identical functions, as illustrated in FIGS. 4A, 4B, 5A and 5B.

It is likewise proposed to use the reactive power frequency function Q(f) as a basic function or unmodified reactive power frequency function. It can then be multiplied by a reactive power voltage weighting factor G_{Q1} which may be between 0 and 1 in order to thereby flatten the reactive power frequency function Q(f). The modified reactive power frequency function Q*(f) is illustrated using dashed lines in FIG. 5A.

A corresponding situation is also proposed for the reactive power voltage function Q(V) which, for weighting, is multiplied by a reactive power voltage weighting factor G_{Q2}. This factor should be between 0 and 1 and results in a flattening of the reactive power voltage function Q(V). The result is the modified reactive power voltage function Q*(V).

In this case too, it is preferably proposed that the two weighting factors G_{Q1} and G_{Q2} in total do not exceed the value 1.

In particular, the reactive power frequency function Q(f) and the reactive power voltage function Q(V) may each be weighted differently by means of these weightings, that is to say in particular these two weighting factors G_{Q1} and G_{Q2}. This makes it possible to vary the influence of the captured grid frequency f, on the one hand, and the captured grid voltage V, on the other hand.

In particular, the influence of the frequency may be selected to be large and the influence of the voltage may be selected to be small or vice versa depending on a grid state and/or a grid characteristic.

The same moreover also applies to the two weighting factors G_{P1} and G_{P2} in FIGS. 4A and 4B or the functions explained there.

Moreover, the same voltage axis as in FIG. 4B has also been selected in FIG. 5B. A lowermost voltage value V′₂, a lower dead band voltage value V′₁, an upper dead band voltage value V₁ and an uppermost voltage value V₂ are therefore also provided. A dead band range 504 is likewise provided.

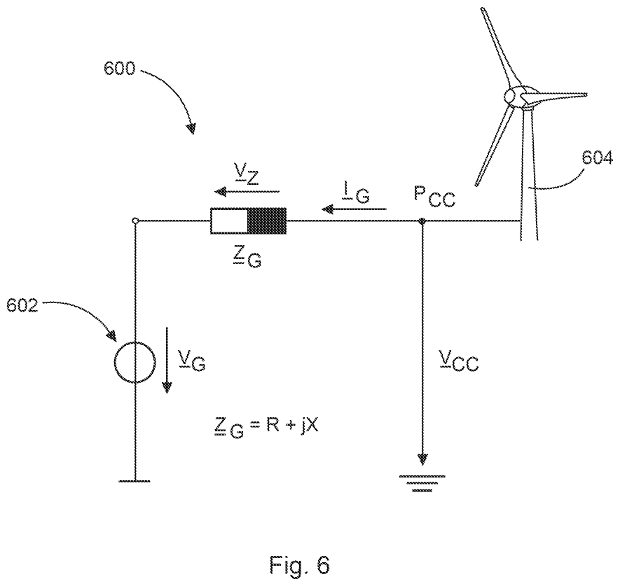

FIG. 6 symbolically shows a grid section 600. In this case, the grid section 600 has an equivalent voltage source 602. An equivalent voltage source 602 indicates an idealized voltage source with a fixed voltage. In this sense, the equivalent voltage source 602 indicates the fixed grid voltage V_{G}. The voltage from an equivalent voltage source 602 is assumed to be fixed, that is to say does not change as a result of the connection. Effects caused by a connection or load are taken into account by further elements.

The grid impedance Z_{G} is such a connection which is specifically connected between the equivalent voltage source 602 and the grid connection point P_{CC}. The wind power installation 604 is connected to the grid connection point P_{CC} and therefore feeds power into the electrical supply grid or the grid section 600 via this grid connection point P_{CC}. In this respect, it feeds in an infeed current I_{G}. The result is a grid connection point voltage V_{CC} at the grid connection point P_{CC}. This depends on the equivalent voltage source 602 or the grid voltage V_{G} and the grid impedance Z_{G} and the current IG which has been fed in.

It is therefore proposed to consider this grid impedance Z_{G} which specifically influences the feeding-in by the infeed unit, that is to say the wind power installation 604 here.

In this case, it has been recognized, in particular, that the magnitude of the ratio of non-reactive resistance R to reactance X, that is to say the magnitude of the ratio of the resistance R to the reactance X, may be relevant. The smaller this ratio, the more dominant the reactance X and the greater a phase shift at the grid impedance Z_{G} when feeding in the infeed current I_{G}.

It is therefore proposed, in particular, to take this ratio into account; in particular, such an R/X ratio is a grid characteristic and is preferably intended to be taken into account when setting the active power control function and the reactive power control function.

Described herein is expanding conventional phase angle control and power control in order to function both in conventional electrical supply grids, in which there is a high proportion of conventional infeed units, and in grids with a high penetration of converters. This is achieved by means of a multiply weighted function which changes the weighting and/or the characteristic depending on a grid state variable. In addition to a grid state variable, at least one grid characteristic may also be taken into account for the purpose of changing this weighting of the multiply weighted functions and/or for the purpose of changing their characteristic.

A penetration of converters may be taken into account using a static converter proportion or a dynamic converter proportion.

In particular, the described solution is proposed for converter-controlled infeed units, in particular converter-controlled regenerative infeed units. Converter-controlled infeed units may synonymously also be referred to as converter-based infeed units. Infeed units may synonymously also be referred to as infeed apparatuses or infeed devices.

The proposed method is proposed both for conventional electrical supply grids and for electrical supply grids which have a high penetration of converters or have a high static and/or dynamic converter proportion.

It has been recognized, in particular, that grid support measures may have a different effect depending on the grid characteristic. Conventional grids which therefore have exclusively or predominantly conventional infeed units react to a power change almost exclusively in terms of a frequency and to a reactive power change in terms of the voltage. In the case of a very high penetration of converters, that is to say a small proportion of conventional infeed apparatuses, this dependence may be shifted, however, to a dependence of the frequency on the reactive power and a dependence of the voltage on the active power. In between, both the grid frequency and the grid voltage may have a dual dependence and may each depend both on the active power and on the reactive power.

An important point of the underlying idea is to perform both phase angle control and active power control with multiple dependence on the basis of the grid state. The phase angle control controls or regulates a phase angle of the current to be fed in and therefore a reactive power component. The weighting and/or the functional characteristic of both the phase angle control, that is to say the reactive power control, and the active power control can therefore be set in this case on the basis of the grid state.

FIGS. 4A, 4B, 5A and 5B illustrate, in particular, an adaptation with the aid of a weighting. However, a change of the dead band ranges is a change in the functional characteristic. The dead band ranges can accordingly be changed by changing the lower and upper dead band frequencies or the lower and upper dead band voltages. As a result, the functional characteristic can be changed.

However, it naturally also comes into consideration to carry out both types of change, that is to say both a change using the weighting and simultaneously a change of the dead bands or another change. For example, instead of a straight slope, the branch before and after the respective dead band range can also be selected differently than using a linear function. One possibility would be to take a quadratic function as a basis, that is to say to specify the characteristic curve branch on the basis of a square of the frequency or voltage, to name just one example. However, a piecewise composition, specifically in addition to the piecewise composition of the two oblique arms shown and of the dead band range, also comes into consideration. Each oblique arm may have, for example, two different slope regions, to name a further example.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for exchanging electrical power between an infeed device and an electrical supply grid at a grid connection point,
wherein:
the electrical supply grid has a variable grid voltage and a variable grid frequency and is associated with a nominal voltage and a nominal frequency, and
the exchange of electrical power includes exchanging active and reactive power, and
wherein the method comprises:
controlling the exchange of the active power based on an active power control function that is frequency-dependent and voltage-dependent, wherein
the active power control function sets an additional active power to be fed in, in addition to a basic active power value, based on a determined grid frequency and a determined grid voltage; and
controlling the exchange of the reactive power based on a reactive power control function that is frequency-dependent and voltage-dependent, wherein
the reactive power control function sets an additional reactive power to be fed in, in addition to a basic reactive power value, based on the determined grid frequency and the determined grid voltage, and
the active power control function and the reactive power control function are each set based on:
at least one grid characteristic, and/or
at least one grid state of the electrical supply grid.

2. The method as claimed in claim 1, wherein the infeed device is a wind power installation, a wind farm or a photovoltaic installation.

3. The method as claimed in claim 1, wherein:
the at least one grid characteristic is a static converter proportion, and the static converter proportion represents a ratio of:
power capable of being fed into the electrical supply grid or a grid section of the electrical supply grid by converter-controlled infeed devices to
an overall power capable of being fed into the electrical supply grid or the grid section by all infeed devices, and/or
the at least one grid characteristic is a resistance to a reactance (R/X) ratio at the grid connection point.

4. The method as claimed in claim 3, wherein:
the converter-controlled infeed devices include a wind power installation, a wind farm or a photovoltaic installation, and
all infeed devices include a generator that is not converter-controlled or a power plant that is not converter controlled.

5. The method as claimed in claim 1, wherein the at least one grid state is:
a grid fault, and/or
switch positions for setting or adjusting a grid topology, and/or
a dynamic converter proportion, wherein the dynamic converter proportion represents a ratio of:
power fed into the electrical supply grid or a grid section of the electrical supply grid by converter-controlled infeed devices to
an overall power fed into the electrical supply grid or the grid section by all infeed devices.

6. The method as claimed in claim 1, comprising:
changing at least one control function, selected from the active power control function and the reactive power control function, or changing one or more control subfunctions of a plurality of control subfunctions of the at least one control function by:
selecting the at least one control function or the one or more control subfunctions from a plurality of predetermined control functions, and/or
changing a parameterization, and/or
changing a functional characteristic, wherein the functional characteristic is at least one characteristic from a list including:
a width and/or a position of a dead band range of the at least one control function or of the one or more control subfunctions,
a limit value of the at least one control function or the one or more control subfunctions, and
a gradient or a slope of the at least one control function or the one or more control subfunctions.

7. The method as claimed in claim 6, wherein selecting the at least one control function or the one or more control subfunctions from the plurality of predetermined control functions includes:
selecting the at least one control function from a set of curves or a set of characteristic areas.

8. The method as claimed in claim 1, wherein at least one control function, selected from the active power control function and the reactive power control function, or one or more control subfunctions of a plurality of control subfunctions of the at least one control function varies based on a weighting or a weighting factor.

9. The method as claimed in claim 8, comprising:
setting the at least one control function or the one or more control subfunctions by setting the weighting or the weighting factor.

10. The method as claimed in claim 1, comprising:
implementing the active power control function using:
an active power frequency function that is a first control subfunction of the active power frequency function and represents a relationship between the determined grid frequency and a first active power value, and
an active power voltage function that is a second control subfunction of the active power voltage function and represents a relationship between the determined grid voltage and a second active power value,
determining the additional active power based on the first and second active power values;
setting the active power frequency function using an active power frequency weighting;
setting the active power voltage function using an active power voltage weighting; and
changing the first or second control subfunction by:
changing at least one of the active power frequency weighting or the active power voltage weighting to cause an active power weighting quotient to change, wherein the active power weighting quotient is a quotient between the active power frequency weighting and the active power voltage weighting is changed.

11. The method as claimed in claim 10, wherein the additional reactive power is a sum of the first and second active power values.

12. The method as claimed in claim 1, comprising:
implementing the reactive power control function using:
a reactive power frequency function that is a first control subfunction of the reactive power control function and represents a relationship between the determined grid frequency and a first reactive power value, and
a reactive power voltage function that is a second control subfunction of the reactive power control function and represents a relationship between the determined grid voltage and a second reactive power value;
determining the additional reactive power based on the first and second reactive power values;
setting the reactive power frequency function using a reactive power frequency weighting;
setting the reactive power voltage function using a reactive power voltage weighting; and
changing the first or second control subfunction by:
changing at least one of the reactive power frequency weighting or the reactive power voltage weighting to cause a reactive power weighting quotient to change, wherein the reactive power weighting quotient is a quotient between the reactive power frequency weighting and the reactive power voltage weighting.

13. The method as claimed in claim 12, wherein the additional reactive power is a sum of the first and second reactive power values.

14. The method as claimed in claim 12, comprising:
in response to a static converter proportion increasing or a dynamic converter proportion increasing, changing the first and second control subfunctions to:
reduce an active power weighting quotient, and/or
increase the reactive power weighting quotient, and/or
reduce a magnitude of an active power ratio, wherein the active power ratio represents a ratio of an average normalized slope of an active power frequency function to an average normalized slope of an active power voltage function, and/or
increase a magnitude of a reactive power ratio, wherein the reactive power ratio represents a ratio of an average normalized slope of the reactive power frequency function to a normalized reactive power voltage function.

15. The method as claimed in claim 14, wherein:
the active power ratio represents a ratio of an average normalized slope of the active power frequency function to an average normalized slope of the active power voltage function, wherein:
a slope of the active power frequency function is normalized to a quotient of a nominal power of the infeed device to a maximum permissible frequency deviation of the grid frequency from the nominal frequency, and
a slope of the active power voltage function is normalized to a quotient of the nominal power of the infeed device to a maximum permissible voltage deviation of the grid voltage from the nominal voltage, and
a magnitude of the active power ratio decreases in response to an increasing static converter proportion and/or an increasing dynamic converter proportion, and the magnitude of the active power ratio has a value that is less than 1 in response to the static converter proportion and/or the dynamic converter proportion reaching or exceeding 80%.

16. The method as claimed in claim 12, wherein:
a reactive power ratio represents a ratio of an average normalized slope of the reactive power frequency function to a normalized reactive power voltage function, wherein
a slope of the reactive power frequency function is normalized to a quotient of a nominal power of the infeed device to a maximum permissible frequency deviation of the grid frequency from the nominal frequency, and
a slope of the reactive power voltage function is normalized to a quotient of a nominal power of the infeed device to a maximum permissible voltage deviation of the grid voltage from the nominal voltage, and
a magnitude of the reactive power ratio increases in response to an increasing static converter proportion and/or in response to an increasing dynamic converter proportion, and the magnitude of the reactive power ratio has a value that is greater than 1 in response to the static converter proportion and/or the dynamic converter proportion reaching or exceeding 80%.

17. An infeed device for exchanging electrical power between the infeed device and an electrical supply grid at a grid connection point,
wherein the electrical supply grid has a variable grid voltage and a variable grid frequency and is associated with a nominal voltage and a nominal frequency, and
wherein the infeed device comprises:
a controller configured to:
control the exchange of the electrical power, wherein the exchange of electrical power includes exchanging active and reactive power;
control the exchange of the active power based on an active power control function that is frequency-dependent and voltage-dependent, wherein the active power control function sets an additional active power to be fed in, in addition to a basic active power value, based on a determined grid frequency and a determined grid voltage;
control the exchange of the reactive power based on a reactive power control function that is frequency-dependent and voltage-dependent, wherein
the reactive power control function sets an additional reactive power to be fed in, in addition to a basic reactive power value, based on the determined grid frequency and the determined grid voltage, and
the active power control function and the reactive power control function are each set based on:
at least one grid characteristic; and/or
at least one grid state of the electrical supply grid.

18. The infeed device as claimed in claim 17, comprising:
one or more converters configured to exchange the electrical power with the electrical supply grid, wherein
the controller is configured to control the one or more converters.
